(19) United States
(12) Patent Application Publication
(10) Pub. No.: US 2026/0330677 A1
(43) Pub. Date: Oct. 22, 2026

(54) HIGH ROBUSTNESS VISUAL POSITIONING METHOD FOR AERO-ENGINE BOLTS

(71) Applicant: DALIAN UNIVERSITY OF TECHNOLOGY, Dalian (CN)

(72) Inventors: Bo YUAN, Dalian (CN); Jiahe ZHAO, Dalian (CN); Zeming XIA, Dalian (CN); Shugen LI, Dalian (CN); Haitao JIANG, Dalian (CN); Xiaokai MU, Dalian (CN)

(21) Appl. No.: 19/551,697

(22) Filed: Feb. 27, 2026

Related U.S. Application Data
(63) Continuation of application No. PCT/CN2025/086230, filed on Mar. 31, 2025.

(51) Int. Cl. G06T 7/73; G06T 3/4046; G06T 3/4053; G06T 7/11; G06T 7/136; G06T 7/194; G06T 7/55; G06T 7/60; G06V 10/26; G06V 10/766; G06V 10/774; G06V 10/82; G06V 20/60

(52) U.S. Cl. CPC G06T 7/73; G06T 3/4046; G06T 3/4053; G06T 7/11; G06T 7/136; G06T 7/194; G06T 7/55; G06T 7/60; G06V 10/26; G06V 10/766; G06V 10/774; G06V 10/82; G06V 20/60; G06T 2207/10024; G06T 2207/10028; G06T 2207/20004; G06T 2207/20072; G06T 2207/20081; G06T 2207/20084; G06T 2207/20092; G06T 2207/20132

(57) ABSTRACT

The present invention discloses a high robustness visual positioning method for aero-engine bolts. A cropped region of bolt and a bolt depth map are segmented through deep learning by using color images and depth maps acquired by a RealSense depth camera; multiple ellipse targets are detected in the cropped region of bolt by an ellipse detection method based on super-resolution preprocessing; an ellipse screening method based on a centroid offset vector method is proposed to screen a single ellipse target corresponding to the bottom surface of the bolt; and the depth value of the center of the bottom surface of the bolt is acquired by a symmetric depth mean method, and a three-dimensional coordinate calculation model for the center of the bottom surface of the bolt based on a pinhole camera model is established.

### TECHNICAL FIELD

The present invention belongs to the field of intelligent detection of machine vision and particularly relates to a visual positioning method for aero-engine bolts with strong robustness at shooting angles, which is mainly applied to the connection structure between the rotor drum and the labyrinth seal disk of an aero-engine.

### BACKGROUND

Bolt connections are widely used in the connection between aero-engine rotor discs. To ensure the assembly quality of an aero-engine rotor, it is necessary to measure key connection parameters such as bolt connection stiffness and bolt preload of the inner cavity of the rotor. With the measurement of bolt preload as an example, in the closed and narrow inner cavity of the rotor, it is necessary to ensure that the ultrasonic probe has a high degree of parallelism with the bottom surface of the bolt. In the existing methods, it is necessary to disassemble some parts and rely on manual operation to position the detection probe. In this way, the operation is cumbersome, and the position is poor, seriously affecting the measurement result. Therefore, the measurement of the connection state relies heavily on the visual positioning of bolts, and it is of great significance to carry out in-situ automated inspection of the connection state.

At present, the visual positioning of bolts is mostly still limited to the pixel plane. Although simple template matching or deep learning methods can detect bolts quickly, the results obtained are usually rectangular bounding boxes, making it difficult to position the bottom center of the bolt. In addition, the existing visual positioning methods for bolts have high requirements for the shooting angle of the camera, which requires the optical axis of the camera to be perpendicular to the bottom surface of the bolt being measured. However, the inner cavity space of an aero-engine rotor is narrow, making it difficult to meet the requirements of vertical shooting. Therefore, the visual positioning of the bolt can only be achieved by a large-angle tilt method.

### SUMMARY

To solve the problem proposed in the background, the present invention proposes a high robustness visual positioning method for aero-engine bolts to achieve precise positioning of the bolt in the inner cavity of the aero-engine at any shooting angle.

The technical solution of the present invention comprises the following steps:
Step 1: acquiring color images of the inner cavity of an aero-engine at different shooting angles, annotating the acquired color images by manually enclosing a bolt with a rectangular box, dividing annotation results into a training set and a validation set, and sending the training set and the validation set into an object detection network model based on deep learning for training to convergence.
Step 2: fixing a RealSense depth camera on an automated detection device of a connection state, which has no requirement for shooting angles as long as the bottom surface of the bolt can be captured. After the RealSense depth camera is fixed, acquiring color images and depth maps corresponding to pixels of the color images.
Step 3: deploying weights of a trained neural network on the object detection network model based on deep learning, automatically identifying and selecting a bolt target from the color images captured by the RealSense depth camera, wherein the selected region is called a cropped region of bolt, and meanwhile, extracting a bolt depth map from the depth maps according to the result of the cropped region of bolt.
Step 4: performing super-resolution processing based on a generative adversarial network on the cropped region of bolt, and enlarging the dimension of the cropped region of bolt by n times to obtain more pixels. Since the optical axis of the RealSense depth camera is not perpendicular to the bottom surface of the bolt, the circular bottom surface of the bolt is imprinted as an ellipse in the acquired cropped region of bolt. Detecting multiple ellipse targets in the enlarged cropped region of bolt by an ellipse detection method based on a pixel gradient, and reducing center coordinates and semi-axis dimensions of the acquired ellipse targets to 1/n. The super-resolution processing refers to a method of acquiring more details and information of images according to known image information.
Step 5: based on the ellipse detection result in the cropped region of bolt, screening an unique ellipse corresponding to the bottom surface of the bolt from the multiple ellipse targets by a centroid offset vector method combined with the bolt depth map corresponding to the cropped region of bolt, wherein the central position of the ellipse is the central position of the bottom surface of the bolt.
Step 5 comprises the following steps:
Step 5.1: calling the cropped region of bolt obtained in step 3 CPRB, and defining the area ratio of the ellipse as follows:

$$ϛ = \frac{π a b}{{W}_{CPRB} \cdot {H}_{CPRB}} \qquad ( 1 )$$

wherein a is the semi-major axis of the ellipse, b is the semi-minor axis of the ellipse, W_{CPRB} is the width of CPRB, and H_{CPRB} is the height of CPRB. The oblateness of the ellipse is as follows:

$$γ = \frac{a - b}{a} \qquad ( 2 )$$

Therefore, constraint equations are as follows:

$$\{ \begin{matrix}{ϛ}_{min} < ϛ < {ϛ}_{max} \\ {γ}_{min} < γ < {γ}_{max}\end{matrix} \qquad ( 3 )$$

As the angle between the optical axis of the RealSense depth camera and the bottom surface of the bolt gradually decreases, ζ will gradually increase, and γ will gradually decrease. According to the actual condition, setting the upper and lower thresholds of ζ and γ to include the area ratios and oblateness of all annotated ellipses, and removing a large number of false ellipses through the constraint equations to achieve the preliminary screening of areas and shapes of the ellipses.
Step 5.2: first, expanding a bolt depth map with a dimension of W_{CPRB}×H_{CPRB}, wherein points with a depth value of 0 are invalid depth points, and eliminating and arranging the invalid depth points in ascending order of the depth values to obtain data with a dimension of 1×N_{z}, wherein N_{z} is the number of valid depth points in a bolt depth map. Then creating a frequency distribution histogram according to the depth values, and dividing the frequency distribution histogram into N_{H} groups with equal width. Due to a significant difference between the foreground and background and the depth value of a target bolt, a phenomenon of column discontinuity will occur in the frequency distribution histogram, taking depth values at the left ends of the notches as a truncation threshold T_{d}. For different shooting angles and shooting environments, multiple truncation thresholds T_{d} will occur, so it is necessary to correctly segment depth information of the target bolt by using the truncation threshold: in one CPRB, the proportion of the target bolt in the entire bolt depth map should be greater than 50%, finding the serial number Nₜ of a depth point closest to the truncation threshold; if Nₜ>N_{z}/2, the threshold is a background threshold, thus setting the depth values of all depth points which are greater than the truncation threshold in the bolt depth map to 0; and on the contrary, if Nₜ<N_{z}/2, the threshold is a foreground threshold, setting the depth values of all depth points which are less than the truncation threshold in the bolt depth map to 0, and finally realizing foreground and background elimination of the bolt depth map.
Step 5.3: restoring 3D point cloud data subjected to foreground and background elimination into a form of a depth map. Letting Dₛ be slice depth:

D_{S}=Dₘᵢₙ+τ·(Dₘₐₓ−Dₘᵢₙ) (4)
wherein Dₘₐₓ and Dₘᵢₙ are respectively maximum and minimum values of depth in the depth map, and τ is a slicing factor. When the slicing factor is constant, Dₛ can be continuously adjusted according to the values of Dₘₐₓ and Dₘᵢₙ, so Dₛ is an adaptive threshold. Projecting all valid depth points with the depth value less than Dₛ onto a two-dimensional plane is called a slice of the depth map. With the depth value as mass, the centroid of the slice is:

$$\{ \begin{matrix}{x}_{c} = \frac{{\sum }_{i = 1}^{{n}_{s}} {x}_{i} \cdot {D}_{i}}{{\sum }_{i = 1}^{{n}_{s}} {D}_{i}} \\ {y}_{c} = \frac{{\sum }_{i = 1}^{{n}_{s}} {y}_{i} \cdot {D}_{i}}{{\sum }_{i = 1}^{{n}_{s}} {D}_{i}}\end{matrix} \qquad ( 5 )$$

wherein x_{c} and y_{c} are respectively the abscissa and ordinate of the centroid of the slice, Dᵢ is the depth value of a depth point (xᵢ, yᵢ), and n, is the number of valid depth points in the slice; multiple consecutive slices are obtained by gradually increasing the value of τ; and assuming a total of S_{c} slices, S_{c} centroids are obtained accordingly.
Step 5.4: projecting the centroid of each slice onto the same two-dimensional plane P_{c}, and obtaining the offset direction of the centroid by means of linear fitting.

Establishing a model of a linear regression line as follows:

f(x_{ci}|θ)=θ₀+θ₁x_{ci} (6)
wherein θ₀ and θ₁ are respectively intercept and slope, and x_{ci} is the abscissa of the centroid of an i^{th} slice.

The fitting method is a quadratic fitting method based on Huber Loss, and the loss function of Huber Loss is as follows:

$${L}_{δ} ( {y}_{ci} , f ( {x}_{ci} ) ) = \{ \begin{matrix}\frac{{( {y}_{ci} - f ( {x}_{ci} ) )}^{2}}{2} , \vert {y}_{ci} - f ( {x}_{ci} ) \vert \leq δ \\ δ \cdot \vert {y}_{ci} - f ( {x}_{ci} ) \vert - \frac{{δ}^{2}}{2} , \vert {y}_{ci} - f ( {x}_{ci} ) \vert > δ\end{matrix} \qquad ( 7 )$$

wherein δ is a hyperparameter, and y_{ci} is the ordinate of the centroid of the actual i^{th} slice. Linear parameters θ₀ and θ₁ can be obtained through iteration by optimization methods.

Calculating the squared error of each mass point relative to the linear regression line:

εᵢ=(y_{ci}−f(x_{ci}))² (8)

The mean value of the squared error is:

$$\overline{ε} = {\sum }_{i = 1}^{{S}_{c}} {ε}_{i} \qquad ( 9 )$$

Traversing the squared error of each mass point; when the value of εᵢ is greater than twice that of ε̅, the centroid (x_{ci}, y_{ci}) is an outlier and is eliminated; and finally, performing secondary fitting on the filtered mass points to obtain final θ₀ and θ₁.

Defining a centroid offset vector as \vec{V_{c}}(ρₓ, ρ_{y}·|θ₁|) and ρₓ, ρ_{y}∈{−1, +1} as a direction factor, and ensuring that the vector \vec{V_{c}} points from the nut to the bottom of the bolt by adjusting the values of ρₓ and ρ_{y}. Calculating vectors of all adjacent centroids to obtain a vector group of Gᵥ={\vec{V₁}, \vec{V₂}, . . . , {right arrow over (V_{S}_{_{c}}₋₁)}}, and counting the number Nₓ of vectors with the abscissa greater than 0, if

$${N}_{x} > \frac{{S}_{c} - 1}{2} ,$$

the value of ρₓ is +1, otherwise, the value is −1. Similarly, counting the number N_{y} of vectors with the ordinate greater than 0, if

$${N}_{y} > \frac{{S}_{c} - 1}{2} ,$$

the value of ρ_{y} is +1, otherwise, the value is −1.

To screen a final ellipse, defining the confidence score of the ellipse as follows:

projₑ=\vec{Vₑ}·\vec{V_{c}} (10)
wherein \vec{Vₑ} is a vector from the center of the ellipse to the origin of the pixel coordinates, the confidence score of each ellipse is calculated, and the ellipse with the highest score is the final ellipse screened.
Step 6: letting the ellipse corresponding to the bottom surface of the bolt be E₁ and E₂ be a concentric ellipse of E₁ which is proportionally reduced to a times the original ellipse, wherein α∈(0,1). By selecting an appropriate a value, finding all symmetrical valid points inside the ellipse E₂, acquiring the depth values of the pixels according to the depth maps, and calculating the mean value of the depth values to finally obtain the depth value of the center of the bottom surface of the bolt.
Step 7: calculating the coordinates of the center of the bottom surface of the bolt in the camera coordinate system based on a pinhole camera model by using the depth value of the center of the bottom surface of the bolt acquired in step 6 combined with intrinsics of the RealSense depth camera.

Compared with the prior art, the present invention has the following significant advantages: (1) the super-resolution algorithm is combined with the ellipse detection algorithm, which greatly improves the effect of the ellipse detection algorithm and reduces the omission factor of the ellipse of the bottom surface of the bolt. (2) An ellipse screening method based on a centroid offset vector method is proposed, which greatly reduces the interference of other ellipse features and can accurately screen the ellipse corresponding to the bottom surface of the bolt. (3) A symmetric depth mean method is proposed, which enables the depth value of the bottom center of the bolt to still be calculated when a hole is found in the depth map of the bottom surface of the bolt. The present invention is experimentally verified in the inner cavity environment of a real aero-engine rotor. Experimental results show that the present invention has high positioning accuracy and strong robustness for aero-engine bolts and is capable of guiding automated detection probes.

### DESCRIPTION OF DRAWINGS

FIG. 1 is a flow chart of a high robustness visual positioning method for aero-engine bolts;

FIG. 2 is a flow chart of an ellipse screening method based on a centroid offset vector method;

FIG. 3 is a schematic diagram of a symmetric depth mean method;

FIG. 4 shows three-dimensional positioning results of a bolt at different shooting angles in an embodiment, wherein (a) is a mean absolute error in X direction, (b) is a mean absolute error in Y direction, and (c) is a mean absolute error in Z direction;

FIG. 5 is a color image acquired in an embodiment;

FIG. 6 is a depth map acquired in an embodiment;

FIG. 7 is a cropped region of bolt acquired in an embodiment;

FIG. 8 is a bolt depth map acquired in an embodiment;

FIG. 9 shows a result of ellipse detection of a cropped region of bolt in an embodiment;

FIG. 10 is a result of slicing a bolt depth map in an embodiment;

FIG. 11 shows a result of ellipse screening in an embodiment.

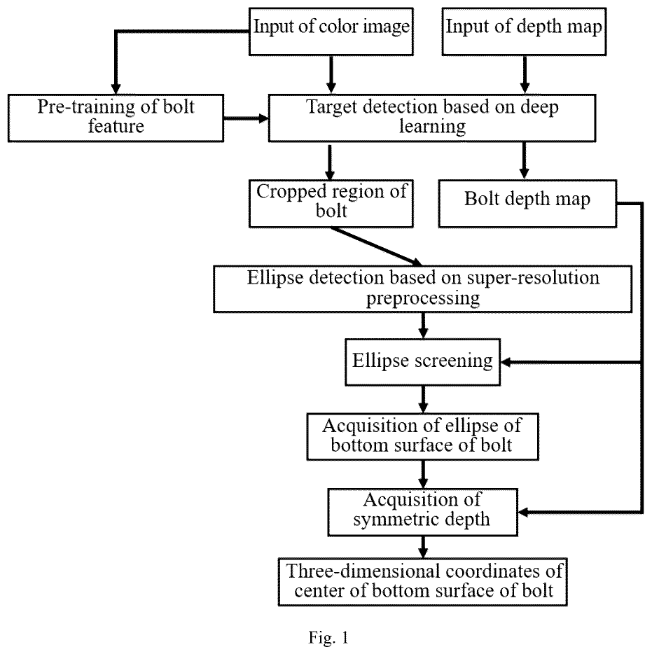

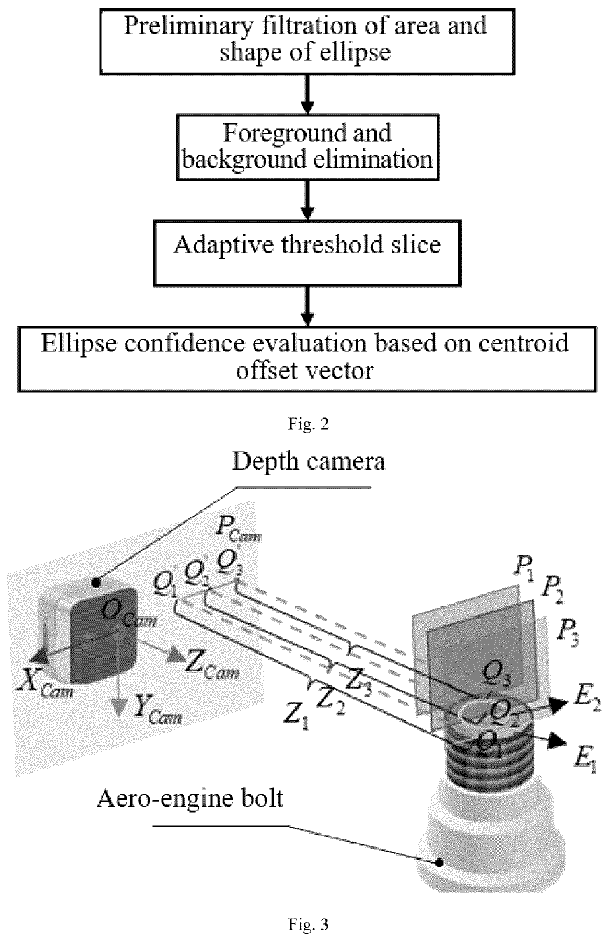

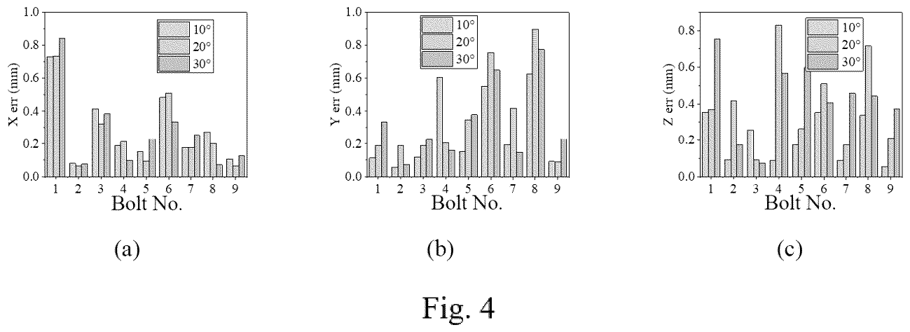

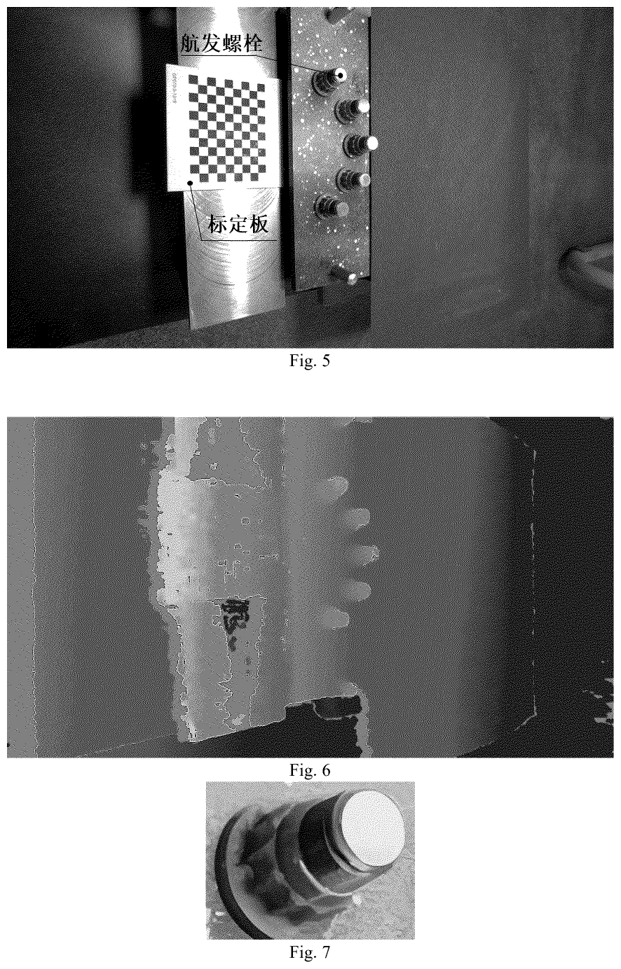

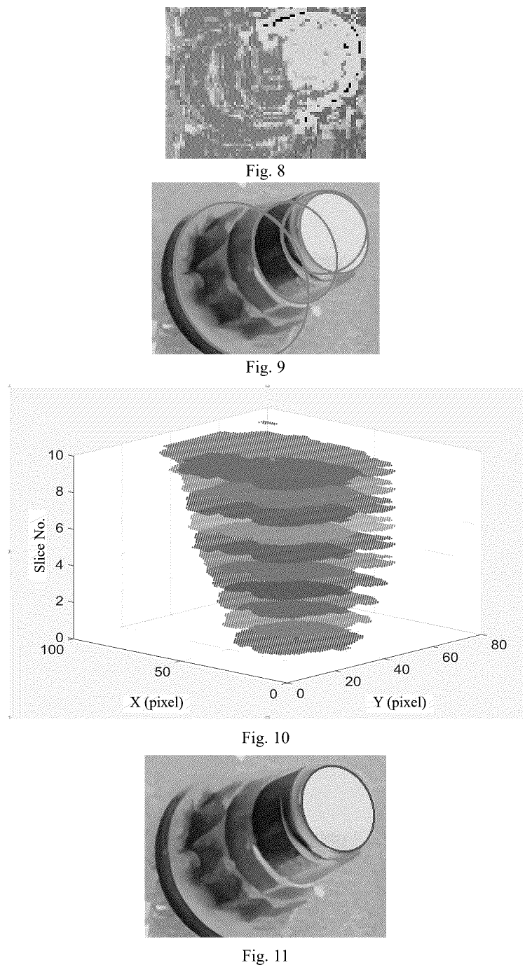

### DETAILED DESCRIPTION

Specific embodiments of the present invention is further detailed below in combination with drawings. The description is not restrictive, and the actual use mode is not limited thereto. An embodiment provided by the present invention comprises:
Step 1:800 color images of the inner cavity of an aero-engine including an aero-engine bolt are acquired through devices such as a cell phone and a RealSense depth camera, the acquired color images are annotated by manually enclosing a bolt with a rectangular box, annotation results are divided into a training set and a validation set in a proportion of 8:2, and the training set and the validation set are sent into an object detection network model based on deep learning for 100 generations of training to convergence.
Step 2: a RealSense depth camera is fixed on a camera mount, which has no restriction on shooting angles as long as the bottom surface of the bolt can be captured. After the RealSense depth camera is fixed, color images and depth maps corresponding to pixels of the color images are acquired.
Step 3: weights of a trained neural network are deployed on the object detection network model based on deep learning, a bolt target is automatically identified and selected from the color images captured by the RealSense depth camera, and a cropped region of bolt and a bolt depth map are extracted from the depth maps and color images respectively.
Step 4: the dimension of the cropped region of bolt is enlarged by 4 times by a super-resolution method based on a generative adversarial network to obtain more pixels. The super-resolution processing refers to a method of acquiring more details and information of images according to known image information. Since the optical axis of the RealSense depth camera is not perpendicular to the bottom surface of the bolt, the circular bottom surface of the bolt is imprinted as an ellipse in the acquired cropped region of bolt. Multiple ellipse targets are detected in the enlarged cropped region of bolt by an ellipse detection method based on a pixel gradient, and center coordinates and semi-axis dimensions of the acquired ellipse targets are reduced to ¼.
Step 5: based on the ellipse detection result in the cropped region of bolt, an unique ellipse corresponding to the bottom surface of the bolt is screened from the multiple ellipse targets combined with the bolt depth map corresponding to the cropped region of bolt, wherein the central position of the ellipse is the central position of the bottom surface of the bolt.
Step 5 comprises the following steps:
Step 5.1: according to multiple cropped regions of bolt obtained from real measurement scenarios, the ellipse of the bottom surface of the bolt is manually annotated, the area ratio ζ and oblateness γ of the annotated ellipse are calculated, and the area ratio of the ellipse is defined as follows:

$$ϛ = \frac{π a b}{{W}_{CPRB} \cdot {H}_{CPRB}} \qquad ( 1 )$$

wherein a is the semi-major axis of the ellipse, b is the semi-minor axis of the ellipse, W_{CPRB} is the width of CPRB, and H_{CPRB} is the height of CPRB. The oblateness of the ellipse is as follows:

$$γ = \frac{a - b}{a} \qquad ( 2 )$$

Therefore, constraint equations are as follows:

$$\{ \begin{matrix}{ϛ}_{min} < ϛ < {ϛ}_{max} \\ {γ}_{min} < γ < {γ}_{max}\end{matrix} \qquad ( 3 )$$

As the angle between the optical axis of the RealSense depth camera and the bottom surface of the bolt gradually decreases, ζ will gradually increase, and γ will gradually decrease. According to the calculation results, the upper and lower thresholds of ζ and γ are set to include the area ratios and oblateness of all annotated ellipses. A large number of false ellipses can be removed through the constraint equations to achieve the preliminary screening of areas and shapes of the ellipses.
Step 5.2: interference targets that are either too close or too far away may randomly occur in the actual shooting environment, which can cause the depth values of different pixels in the depth map to vary too much, making it difficult to extract useful information. To solve this problem, first, a bolt depth map with a dimension of W_{CPRB}×H_{CPRB} is expanded, wherein points with a depth value of 0 are invalid depth points, and the invalid depth points are eliminated and arranged in ascending order of the depth values to obtain data with a dimension of 1×N_{z}, wherein N_{z} is the number of valid depth points in a bolt depth map. Then, a frequency distribution histogram is created according to the depth values and divided into 20 groups with equal width. Due to a significant difference between the foreground and background and the depth value of a target bolt, a phenomenon of column discontinuity will occur in the frequency distribution histogram, and the depth values at the left ends of the notches are taken as a truncation threshold T_{d}. For different shooting angles and shooting environments, multiple truncation thresholds T_{d} will occur, so it is necessary to correctly segment depth information of the target bolt by using the truncation threshold. Apparently, in one CPRB, the proportion of the target bolt in the entire bolt depth map should be greater than 50%, and the serial number Nₜ of a depth point closest to the truncation threshold is found; if Nₜ>N_{z}/2, the threshold is a background threshold, so the depth values of all depth points which are greater than the truncation threshold in the bolt depth map are set to 0; and on the contrary, if Nₜ<N_{z}/2, the threshold is a foreground threshold, and the depth values of all depth points which are less than the truncation threshold in the bolt depth map are set to 0, finally realizing foreground and background elimination of the bolt depth map.
Step 5.3: 3D point cloud data subjected to foreground and background elimination are restored into a form of a depth map. Letting Dₛ be slice depth:

D_{S}=Dₘᵢₙ+τ·(Dₘₐₓ−Dₘᵢₙ) (4)
wherein Dₘₐₓ and Dₘᵢₙ are respectively maximum and minimum values of depth in the depth map, and τ is a slicing factor. When the slicing factor is constant, Dₛ can be continuously adjusted according to the values of Dₘₐₓ and Dₘᵢₙ, so Dₛ is an adaptive threshold. Projecting all valid depth points with the depth value less than Dₛ onto a two-dimensional plane is called a slice of the depth map. With the depth value as mass, the centroid of the slice is:

$$\{ \begin{matrix}{x}_{c} = \frac{{\sum }_{i = 1}^{{n}_{s}} {x}_{i} \cdot {D}_{i}}{{\sum }_{i = 1}^{{n}_{s}} {D}_{i}} \\ {y}_{c} = \frac{{\sum }_{i = 1}^{{n}_{s}} {y}_{i} \cdot {D}_{i}}{{\sum }_{i = 1}^{{n}_{s}} {D}_{i}}\end{matrix} \qquad ( 5 )$$

wherein x_{c} and y_{c} are respectively the abscissa and ordinate of the centroid of the slice, Dᵢ is the depth value of a depth point (xᵢ, yᵢ), and n, is the number of valid depth points in the slice. The base value of the slicing factor τ is set to 0.3, and is increased 10 times in sequence at a step pitch of 0.03 to obtain 10 slices. With the depth value as mass, the abscissas and ordinates of the centroids of the 10 slices are calculated respectively.
Step 5.4: it can be found through observation that the offset of the centroid can reflect the direction of the bolt to a certain extent. Therefore, the coordinates of the 10 centroids obtained are plotted in a two-dimensional plane, and the offset directions of the centroids are obtained by means of linear fitting. A linear model is established as follows:

f(x_{ci}|θ)=θ₀+θ₁x_{ci} (6)
wherein θ₀ and θ₁ are respectively intercept and slope, and x_{ci} is the abscissa of the centroid of an i^{th} slice.

The mean square error is sensitive to outliers, and the fitting result is prone to interference and is not applicable. Linear fitting is performed on the centroids by a quadratic fitting method based on Huber Loss, and the loss function of Huber Loss is as follows:

$${L}_{δ} ( {y}_{ci} , f ( {x}_{ci} ) ) = \{ \begin{matrix}\frac{{( {y}_{ci} - f ( {x}_{ci} ) )}^{2}}{2} , \vert {y}_{ci} - f ( {x}_{ci} ) \vert \leq δ \\ δ \cdot \vert {y}_{ci} - f ( {x}_{ci} ) \vert - \frac{{δ}^{2}}{2} , \vert {y}_{ci} - f ( {x}_{ci} ) \vert > δ\end{matrix} \qquad ( 7 )$$

y_{ci} is the ordinate of the centroid of the actual i^{th} slice. A hyperparameter δ in Huber Loss is set to 1.5. Linear parameters θ₀ and θ₁ can be obtained through iteration by optimization methods. To further enhance the linear regression accuracy, the squared error of each mass point relative to the regression line is calculated using the fitting result:

εᵢ=(y_{ci}−f(x_{ci}))² (8)

The mean value of the squared error is:

$$\overline{ε} = {\sum }_{i = 1}^{{S}_{c}} {ε}_{i} \qquad ( 9 )$$

The squared error of each mass point is traversed; when the value of εᵢ is greater than twice that of ε̅, the centroid (x_{ci}, y_{ci}) is an outlier and is eliminated; and finally, secondary fitting is performed on the filtered mass points to obtain final θ₀ and θ₁.

A centroid offset vector is defined as \vec{V_{c}}(ρₓ, ρ_{y}·|θ₁|), ρₓ, ρ_{y}∈{−1, +1} is a direction factor, and it can be ensured by adjusting the values of ρₓ and ρ_{y} that the vector \vec{V_{c}} points from the nut to the bottom of the bolt. The vectors of all adjacent centroids are calculated to obtain a vector group of Gᵥ={\vec{V₁}, \vec{V₂}, . . . , {right arrow over (V_{S}_{_{c}}₋₁)}}, and the number Nₓ of vectors with the abscissa greater than 0 is counted; if

$${N}_{x} > \frac{{S}_{c} - 1}{2} ,$$

the value of ρₓ is +1; otherwise, the value is −1. Similarly, the number N_{y} of vectors with the ordinate greater than 0 is counted; if

$${N}_{y} > \frac{{S}_{c} - 1}{2} ,$$

the value of ρ_{y} is +1; otherwise, the value is −1. Based on the center coordinates of the multiple ellipses obtained in the previous steps, the confidence score projₑ of each ellipse is calculated, and the confidence score of the ellipse is defined as follows:

projₑ=\vec{Vₑ}·\vec{V_{c}} (10)
wherein \vec{Vₑ} is a vector from the center of the ellipse to the origin of the pixel coordinates, and after the confidence score of each ellipse is calculated, the ellipse with the highest score is the final ellipse screened.
Step 6: due to factors such as lighting, noise and reflection, many holes will occur in the actual depth map obtained, resulting in the inability to obtain the depth value of the central position of the bottom surface of some bolts. To solve this problem, a symmetric depth mean method is proposed. A valid point is a pixel in the depth map where a valid depth value can be obtained. If two valid points are symmetrical about the center of the bottom surface of the bolt, the two points are called a group of symmetrical valid points. As shown in FIG. 3, E₁ is the ellipse of the bottom of the detected bolt, Q₂ is the center point of the ellipse, Q₁ and Q₃ are two points on the edge of the ellipse E₁ and are symmetrical about Q₂, and P₁, P₂ and P₃ are respectively planes which contain Q₁, Q₂ and Q₃ and are parallel to the camera plane. The depth value measured by the RealSense depth camera is the distance from an object to the camera plane. Therefore, Z₁, Z₂ and Z₃ are respectively the depth values of points Q₁, Q₂ and Q₃ relative to the RealSense depth camera. From the geometric properties of trapezoids, it can be obtained that:

$${Z}_{2} = \frac{{Z}_{1} + {Z}_{3}}{2} \qquad ( 11 )$$

Therefore, even if the depth value of the center of the ellipse is missing, the depth value of the center of the ellipse can be solved given the depth values of any two points that are symmetrical about the center inside the ellipse. To reduce the error of the estimated value, it is necessary to select a sufficient number of calculation points and be as close as possible to the center point of the ellipse. E₂ is a concentric ellipse of E₁ which is proportionally reduced to 0.5 time the original ellipse. All symmetrical valid points are found inside the ellipse E₂, the depth values of the pixels are acquired according to the depth maps, and the mean value of the depth values is calculated to finally obtain the depth value of the center point of the ellipse.
Step 7: the coordinates of the center of the bottom surface of the bolt in the camera coordinate system are calculated based on a pinhole camera model by using the depth value of the center of the bottom surface of the bolt acquired in step 6 combined with intrinsics of the RealSense depth camera.

1. A high robustness visual positioning method for aero-engine bolts, comprising the following steps:
step 1: acquiring color images of the inner cavity of an aero-engine at different shooting angles, annotating the acquired color images by manually enclosing a bolt with a rectangular box, dividing annotation results into a training set and a validation set, and sending the training set and the validation set into an object detection network model based on deep learning for training to convergence;
step 2: fixing a RealSense depth camera on an automated detection device of a connection state, which has no requirement for shooting angles as long as the bottom surface of the bolt can be captured; and after the RealSense depth camera is fixed, acquiring color images and depth maps corresponding to pixels of the color images;
step 3: deploying weights of a trained neural network on the object detection network model based on deep learning, automatically identifying and selecting a bolt target from the color images captured by the RealSense depth camera, wherein the selected region is called a cropped region of bolt, and meanwhile, extracting a bolt depth map from the depth maps according to the result of the cropped region of bolt;
step 4: performing super-resolution processing based on a generative adversarial network on the cropped region of bolt, and enlarging the dimension of the cropped region of bolt by n times to obtain more pixels; and detecting multiple ellipse targets in the enlarged cropped region of bolt by an ellipse detection method based on a pixel gradient, and reducing center coordinates and semi-axis dimensions of the acquired ellipse targets to 1/n; wherein the super-resolution processing refers to a method of acquiring more details and information of images according to known image information;
step 5: based on the ellipse detection result in the cropped region of bolt, screening an unique ellipse corresponding to the bottom surface of the bolt from the multiple ellipse targets by a centroid offset vector method combined with the bolt depth map corresponding to the cropped region of bolt, wherein the central position of the ellipse is the central position of the bottom surface of the bolt;
step 6: letting the ellipse corresponding to the bottom surface of the bolt be E₁ and E₂ be a concentric ellipse of E₁ which is proportionally reduced to α times the original ellipse, wherein α∈(0,1); and by selecting an appropriate α value, finding all symmetrical valid points inside the ellipse E₂, acquiring the depth values of the pixels according to the depth maps, and calculating the mean value of the depth values to finally obtain the depth value of the center of the bottom surface of the bolt;
step 7: calculating the coordinates of the center of the bottom surface of the bolt in the camera coordinate system based on a pinhole camera model by using the depth value of the center of the bottom surface of the bolt acquired in step 6 combined with intrinsics of the RealSense depth camera.

2. The high robustness visual positioning method for aero-engine bolts according to claim 1, wherein step 5 comprises the following steps:
step 5.1: calling the cropped region of bolt obtained in step 3 CPRB, and defining the area ratio of the ellipse as follows:
$$ϛ = \frac{π a b}{{W}_{CPRB} \cdot {H}_{CPRB}} \qquad ( 1 )$$
wherein a is the semi-major axis of the ellipse, b is the semi-minor axis of the ellipse, W_{CPRB} is the width of CPRB, and H_{CPRB} is the height of CPRB; and the oblateness of the ellipse is as follows:
$$γ = \frac{a - b}{a} \qquad ( 2 )$$
therefore, constraint equations are as follows:
$$\{ \begin{matrix}{ϛ}_{min} < ϛ < {ϛ}_{max} \\ {γ}_{min} < γ < {γ}_{max}\end{matrix} \qquad ( 3 )$$
as the angle between the optical axis of the RealSense depth camera and the bottom surface of the bolt gradually decreases, ζ will gradually increase, and γ will gradually decrease; and according to the actual condition, setting the upper and lower thresholds of ζ and γ to include the area ratios and oblateness of all annotated ellipses, and removing a large number of false ellipses through the constraint equations to achieve the preliminary screening of areas and shapes of the ellipses;
step 5.2: first, expanding a bolt depth map with a dimension of W_{CPRB}×H_{CPRB}, wherein points with a depth value of 0 are invalid depth points, and eliminating and arranging the invalid depth points in ascending order of the depth values to obtain data with a dimension of 1×N_{z}, wherein N_{z} is the number of valid depth points in a bolt depth map; then creating a frequency distribution histogram according to the depth values, and dividing the frequency distribution histogram into N_{H} groups with equal width; due to a significant difference between the foreground and background and the depth value of a target bolt, a phenomenon of column discontinuity will occur in the frequency distribution histogram, taking the depth values at the left ends of the notches as a truncation threshold T_{d}; for different shooting angles and shooting environments, multiple truncation thresholds T_{d} will occur, segmenting depth information of the target bolt by using the truncation threshold: in one CPRB, the proportion of the target bolt in the entire bolt depth map should be greater than 50%, finding the serial number Nₜ of a depth point closest to the truncation threshold; if Nₜ>N_{z}/2, the threshold is a background threshold, thus setting the depth values of all depth points which are greater than the truncation threshold in the bolt depth map to 0; and on the contrary, if Nₜ<N_{z}/2, the threshold is a foreground threshold, setting the depth values of all depth points which are less than the truncation threshold in the bolt depth map to 0, and finally realizing foreground and background elimination of the bolt depth map;
step 5.3: restoring 3D point cloud data subjected to foreground and background elimination into a form of a depth map; and letting Dₛ be slice depth:
D_{S}=Dₘᵢₙ+τ·(Dₘₐₓ−Dₘᵢₙ) (4)
wherein Dₘₐₓ and Dₘᵢₙ are respectively maximum and minimum values of depth in the depth map, and τ is a slicing factor; when the slicing factor is constant, Dₛ can be continuously adjusted according to the values of Dₘₐₓ and Dₘᵢₙ, so Dₛ is an adaptive threshold; projecting all valid depth points with the depth value less than Dₛ onto a two-dimensional plane is called a slice of the depth map; and with the depth value as mass, the centroid of the slice is:
$$\{ \begin{matrix}{x}_{c} = \frac{{\sum }_{i = 1}^{{n}_{s}} {x}_{i} \cdot {D}_{i}}{{\sum }_{i = 1}^{{n}_{s}} {D}_{i}} \\ {y}_{c} = \frac{{\sum }_{i = 1}^{{n}_{s}} {y}_{i} \cdot {D}_{i}}{{\sum }_{i = 1}^{{n}_{s}} {D}_{i}}\end{matrix} \qquad ( 5 )$$
wherein x_{c} and y_{c} are respectively the abscissa and ordinate of the centroid of the slice, Dᵢ is the depth value of a depth point (xᵢ, yᵢ), and n, is the number of valid depth points in the slice; multiple consecutive slices are obtained by gradually increasing the value of τ; and assuming a total of S_{c} slices, S_{c} centroids are obtained accordingly;
step 5.4: projecting the centroid of each slice onto the same two-dimensional plane P_{c}, and obtaining the offset direction of the centroid by means of linear fitting;
establishing a model of a linear regression line as follows:
f(x_{ci}|θ)=θ₀+θ₁x_{ci} (6)
wherein θ₀ and θ₁ are respectively intercept and slope, and x_{ci} is the abscissa of the centroid of an i^{th} slice;
the fitting method is a quadratic fitting method based on Huber Loss, and the loss function of Huber Loss is as follows:
$${L}_{δ} ( {y}_{ci} , f ( {x}_{ci} ) ) = \{ \begin{matrix}\frac{{( {y}_{ci} - f ( {x}_{ci} ) )}^{2}}{2} , \vert {y}_{ci} - f ( {x}_{ci} ) \vert \leq δ \\ δ \cdot \vert {y}_{ci} - f ( {x}_{ci} ) \vert - \frac{{δ}^{2}}{2} , \vert {y}_{ci} - f ( {x}_{ci} ) \vert > δ\end{matrix} \qquad ( 7 )$$
wherein δ is a hyperparameter, and y_{ci} is the ordinate of the centroid of the actual i^{th} slice; and linear parameters θ₀ and θ₁ can be obtained through iteration by optimization methods;
calculating the squared error of each mass point relative to the linear regression line:
εᵢ=(y_{ci}−f(x_{ci}))² (8)
the mean value of the squared error is:
$$\overline{ε} = {\sum }_{i = 1}^{{S}_{c}} {ε}_{i} \qquad ( 9 )$$
traversing the squared error of each mass point; when the value of εᵢ is greater than twice that of ε̅, the centroid (x_{ci}, y_{ci}) is an outlier and is eliminated; and finally, performing secondary fitting on the filtered mass points to obtain final θ₀ and θ₁;
defining a centroid offset vector as \vec{V_{c}} (ρₓ, ρ_{y}·|θ₁|) and ρₓ, ρ_{y}∈{−1, +1} as a direction factor, and ensuring that the vector \vec{V_{c}} points from the nut to the bottom of the bolt by adjusting the values of ρₓ and ρ_{y}; calculating vectors of all adjacent centroids to obtain a vector group of Gᵥ={\vec{V₁}, \vec{V₂}, . . . , {right arrow over (V_{S}_{_{c}}₋₁)}}, and counting the number Nₓ of vectors with the abscissa greater than 0, if
$${N}_{x} > \frac{{S}_{c} - 1}{2} ,$$
the value of ρₓ is +1, otherwise, the value is −1; and similarly, counting the number N_{y} of vectors with the ordinate greater than 0, if
$${N}_{y} > \frac{{S}_{c} - 1}{2} ,$$
the value of ρ_{y} is +1, otherwise, the value is −1;
to screen a final ellipse, defining the confidence score of the ellipse as follows:
projₑ=\vec{Vₑ}·\vec{V_{c}} (10)
wherein \vec{Vₑ} is a vector from the center of the ellipse to the origin of the pixel coordinates, the confidence score of each ellipse is calculated, and the ellipse with the highest score is the final ellipse screened.
